(19) United States
(12) Patent Application Publication
(10) Pub. No.: US 2026/0176212 A1
(43) Pub. Date: Jun. 25, 2026

(54) ROCKET SOLID PROPELLANT GRAIN

(71) Applicant: Siec Badawcza Lukasiewicz - Instytut Lotnictwa, Warszawa (PL)

(72) Inventor: Grzegorz Pela, Warszawa (PL)

(21) Appl. No.: 17/955,806

(22) Filed: Sep. 29, 2022

(30) Foreign Application Priority Data
Sep. 29, 2021 (PL) P.439066

(51) Int. Cl. C06B 45/12; F02K 9/08

(52) U.S. Cl. CPC C06B 45/12; F02K 9/08

(57) ABSTRACT

The subject of the invention is a solid rocket propellant grain comprising frontal surfaces and a lateral surface, characterised in that it comprises a first type layer which is completely filled in cross-section with a solid propellant material with an inhibited lateral surface (101a), and a second type layer which has at least one recess (103) in a solid propellant material with a non-inhibited lateral surface (101b), wherein at least one second type layer is surrounded by the first type layer on both sides.

The subject of the invention is a grain of a solid rocket propellant material.

The most commonly used type of a solid propellant grain for rocket motors so far is a cylindrical grain with an inhibited outer surface and a core channel along its entire length with a constant or variable cross-section (e.g. circular or star-type). This grain is characterized by a relatively high thrust and a short burning time.

From U.S. Pat. No. 6,530,327B2, various solid fuel configurations are known with a core channel along the entire length of a cylindrical grain, including star, moon and C-shaped core cross-sections.

Another common solution is a grain without a core channel with an outer surface and one of the frontal surfaces being inhibited. It is characterized by low thrust and long burning time.

However, the solutions mentioned share relatively large differences in thrust and operating time for a given propellant material. In order to obtain intermediate values of thrust and operating time, it is often necessary to use a different propellant material or to change dimensions of a combustion chamber in a significant way, most often within its internal diameter.

Polish patent PL235841B1 describes a propellant grain for a rocket motor with an extended operating time, having at least one internal compartment having thermal insulation properties built into an axially symmetrical grain, extending the burning path of the solid propellant material relative to the rocket motor nozzle, wherein the compartment being at least one plate with a diameter smaller than the grain diameter, located coaxially along the grain axis.

The object of the invention is to enable intermediate thrust and operating time values to be obtained without having to alter the propellant material or the design of the combustion chamber significantly.

According to the invention, a solid rocket propellant grain comprising frontal surfaces and a lateral surface is characterized in that it comprises a first type layer which is completely filled in cross-section with a solid propellant material with an inhibited lateral surface, and a second type layer which has at least one recess in a solid propellant material with a non-inhibited lateral surface, wherein at least one second type layer is surrounded by the first type layer on both sides.

In a preferred embodiment, the recess is a groove.

In another preferred embodiment, the recess is a circular hole.

In yet another preferred embodiment, the recess is a polygonal, in particular rectangular, hole.

Preferably, the second type layer has a plurality of recesses in the solid propellant material with a non-inhibited lateral surface. In a preferred embodiment, the plurality of recesses are distributed radially around the longitudinal axis of the grain. In another preferred embodiment, the plurality of recesses each have the same depth. In yet another preferred embodiment, the at least one recess of the plurality of recesses has a different depth to the others.

Preferably, one of the frontal surfaces of the solid rocket propellant grain according to the invention is inhibited.

Preferably, the solid propellant material is a homogeneous solid propellant material.

Preferably, the solid rocket propellant grain is cylindrical in shape.

The solution according to the invention extends the possibilities of designing and selecting thrust curves by obtaining a wide range of propellant burning areas during rocket motor operation in situations where end-burning grains, or those with a core channel and their variations, do not allow satisfactory thrust profiles to be obtained.

The present invention is illustrated by the embodiments shown in the drawings in which

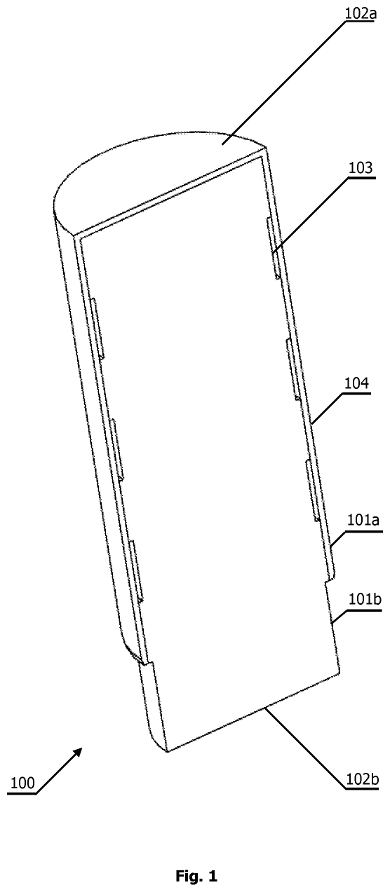

FIG. 1 shows an embodiment of the grain in a perspective view in longitudinal section,

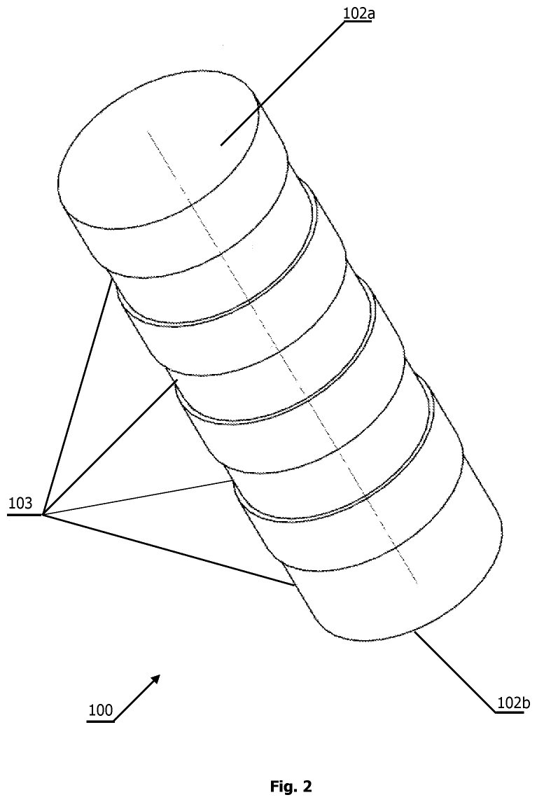

FIG. 2 shows the grain of FIG. 1 before application of the inhibitor,

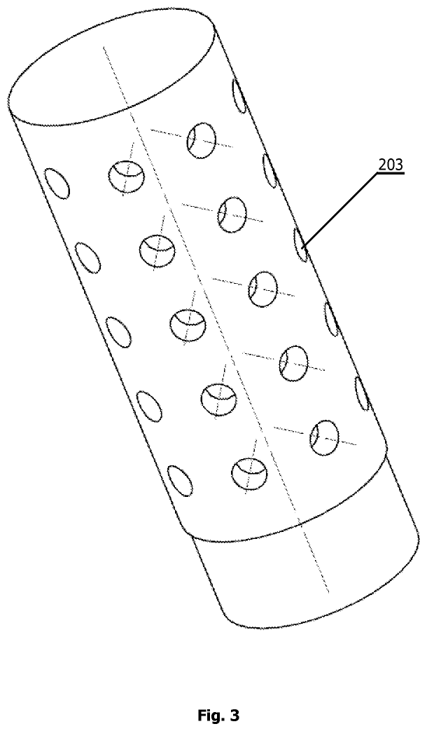

FIG. 3 shows the grain with round holes before application of the inhibitor,

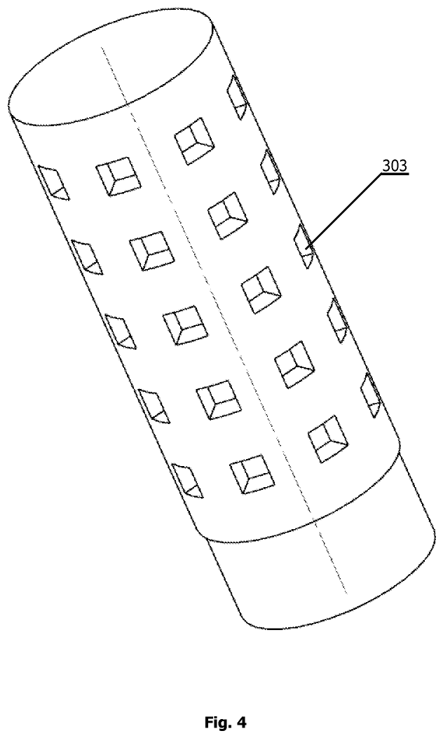

FIG. 4 shows the grain with polygonal holes before application of the inhibitor,

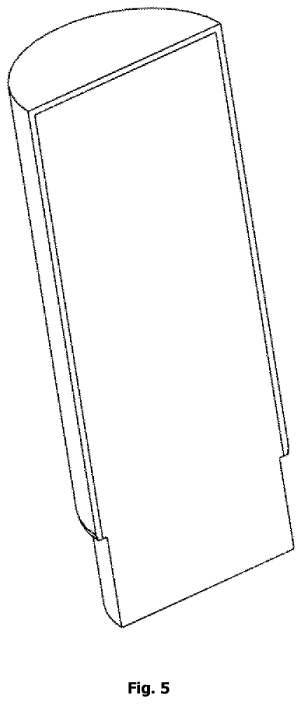

FIG. 5 shows the comparative grain known from the prior art,

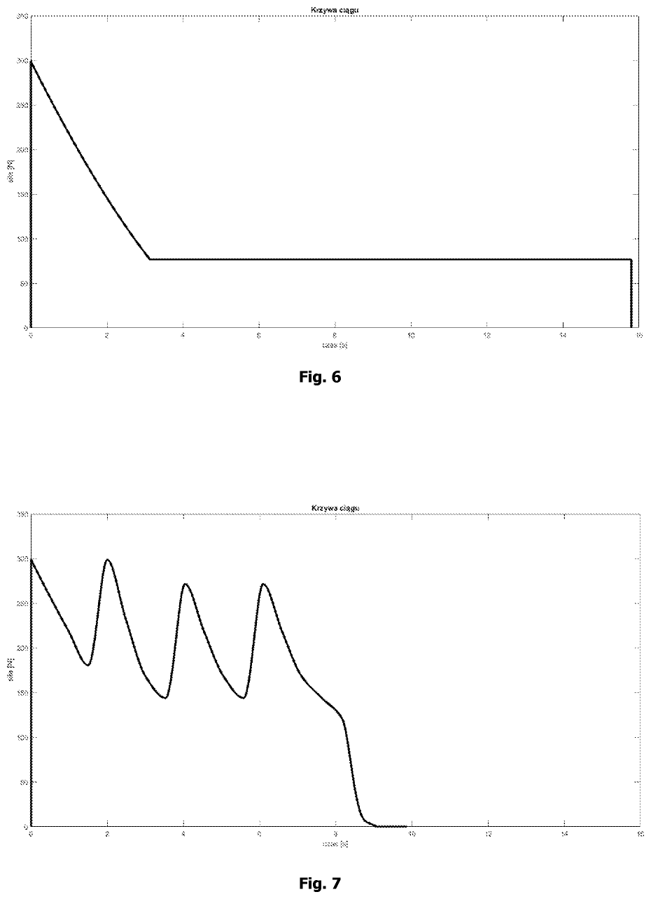

FIG. 6 shows the thrust curve of the comparative grain of FIG. 5,

FIG. 7 shows the thrust curve of the grain according to the embodiment shown in FIG. 1.

FIG. 1 shows an embodiment of a solid rocket propellant grain 100 in a form of a cylinder comprising frontal surfaces 102a, 102b and lateral surfaces 101a, 101b, wherein the frontal surface 102a is covered by a tape inhibitor 104, and the frontal surface 102b is non-inhibited. The grain 100 in the embodiment is a homogeneous block of propellant material, fragments of which (referred to herein as layers) have been modified by excavation to give two types of layers of which a first type layer is completely filled in cross-section with a solid propellant material with an inhibited lateral surface 101a and a second type layer has a circumferential recess 103 in a solid propellant material with a non-inhibited lateral surface 101b, wherein each of the three second type layers having the recess 103 is surrounded by the first type layer on both sides. Since in the embodiment the first and second type layers are cylindrical in shape, the grain 100 thus comprises two types of cylinders connected by bases and constituting in this embodiment a homogeneous block of propellant material, wherein for at least one cylinder of the second type layer, both bottom and upper bases adhere to the base of the first type layer cylinder. The grain 100 does not have a core channel. Alternatively, the core channel may be present only up to a certain depth. The grain 100 according to the embodiment burns frontally and radially. During operation, as the grain shortens, successive burning areas of the recesses 103 made earlier are exposed, thereby increasing the burning area and thus the thrust produced. This allows for a relatively high average thrust over a relatively long operating time.

FIG. 2 shows the grain of FIG. 1 prior to application of a tape inhibitor (e.g., made of ethyl cellulose), showing circumferential recesses 103 made in a whole grain of homogeneous material (e.g., nitrocellulose and nitro-glycerine based) after removal treatment (e.g., by cutting) to obtain the appropriate external geometry.

Exemplary grain geometries after modification, but prior to inhibitor application, are shown in FIGS. 3 and 4, wherein the recesses 103 shown in FIG. 3 have a shape of circular holes and the recesses 103 shown in FIG. 4 have a shape of polygonal holes.

In order to compare the properties of the grain according to the invention, an exemplary comparative grain was made as illustrated in the longitudinal section view in FIG. 5. The comparative grain was made analogously to that of the embodiment in FIG. 1, with the difference that the comparative grain did not contain recesses on the lateral surface coated with an inhibitor.

FIG. 6 shows a thrust curve obtained for the comparative grain, and FIG. 7 shows a thrust curve obtained for the embodiment illustrated in FIG. 1. Both thrust curves were approximated for the same homogeneous propellant material and the same dimensions of the combustion chamber assuming an ideal exhaust gas expansion to ambient pressure, adiabatic flow, no losses.

The comparative grain, being an end-burning grain with the inhibitor removed on a fragment of its length, generates a curve of the type: boost and sustain. In turn, the grain according to the embodiment illustrated in FIG. 1 allowed to increase the average thrust value and shorten the operating time which is still much longer than the boost phase of the comparative thrust curve. It should be noted at this point that an appropriate choice of the number and height of the grooves would result in less thrust fluctuations for the grain according to the invention. The selection of the shape and arrangement of the recesses in the grain according to the invention makes it possible to obtain a low-pulsation thrust with a relatively high value and a long operating time. It should also be noted that, in the comparative example discussed, the grain with a core channel along its entire length would not allow an operating time of more than 3 seconds, referred to in this example as a time of a boost phase.

The grain according to the invention allows to delay an activation of additional burning areas, so that the motor is able to operate for a relatively long time compared to a grain with a core channel along its entire length, and with a relatively high thrust compared to an end-burning grain. Thus, the invention allows to increase the average thrust in a sustain phase of the thrust curve, while shortening its duration, or to lower the average thrust in the boost phase of the thrust curve, with a simultaneous extension of its duration—these changes can be implemented with a relatively large freedom. The constructor gets a wide range of possibilities for modelling a thrust curve of a solid rocket motor in a significant way which is largely independent of the propellant material and motor design. The invention provides a grain having an intermediate form between the end-burning grain (so-called cigarette) and a grain with a core channel along its entire length.

The advantage of the invention is that it is possible to obtain thrust curves with a relatively long burning time and a relatively high average thrust without the need to change a chemical composition of a propellant material or far-reaching changes to a motor design. As a result, it is possible to more quickly adapt a motor containing the grain according to the invention to a new thrust curve and to new mission requirements. The invention also makes it possible to create a series of motors with very different thrust curves compatible with a given rocket design at a low cost, and also gives the opportunity to increase the flight altitude or range of the rocket.

The disclosed embodiments of the invention are intended to be illustrative only and not limiting the scope of protection of the invention as defined by the claims.

1. A solid rocket propellant grain comprising frontal surfaces and a lateral surface, characterised in that it comprises:
a first type layer which is completely filled in cross-section with a solid propellant material with an inhibited lateral surface (101a), and
a second type layer which has at least one recess (103) in a solid propellant material with a non-inhibited lateral surface (101b),
wherein at least one second type layer is surrounded by the first type layer on both sides.

2. The solid rocket propellant grain according to claim 1, wherein the recess (103) is a groove.

3. The solid rocket propellant grain according to claim 1, wherein the recess (103) is a circular hole (203).

4. The solid rocket propellant grain according to claim 1, wherein the recess (103) is a polygonal hole (303).

5. The solid rocket propellant grain according to claim 1, wherein the recess (103) is a rectangular hole.

6. The solid rocket propellant grain according to one of claims 1-5, wherein the second type layer has a plurality of recesses (103) in the solid propellant material with a non-inhibited lateral surface (101b).

7. The solid rocket propellant grain according to claim 6, wherein the plurality of recesses (103) are distributed radially around the longitudinal axis of the grain (100).

8. The solid rocket propellant grain according to claim 6, wherein the plurality of recesses (103) each have the same depth.

9. The solid rocket propellant grain according to claim 6, wherein the at least one recess (103) of the plurality of recesses (103) has a different depth to the others.

10. The solid rocket propellant grain according to one of claims 1-9, wherein one of the frontal surfaces (102a, 102b) is inhibited.

11. The solid rocket propellant grain according to one of claims 1-10, wherein the solid propellant material is a homogeneous solid propellant material.

12. The solid rocket propellant grain according to one of claims 1-11, wherein the grain (100) is cylindrical in shape.
